(19) United States
(12) Patent Application Publication
(10) Pub. No.: US 2015/0012278 A1
(43) Pub. Date: Jan. 8, 2015

(54) SYSTEM AND METHOD FOR TRANSFERRING DATA TO A CUSTOMER RELATIONSHIP MANAGEMENT PLATFORM

(71) Applicant: Michael D. Metcalf, Lake Forest, CA (US)

(72) Inventor: Michael D. Metcalf, Lake Forest, CA (US)

(21) Appl. No.: 14/323,381

(22) Filed: Jul. 3, 2014

Related U.S. Application Data
(60) Provisional application No. 61/843,028, filed on Jul. 4, 2013.

(51) Int. Cl. G10L 25/48; G06Q 30/02

(52) U.S. Cl. CPC G10L 25/48; G06Q 30/0201
USPC 704/270.1

(57) ABSTRACT

A system and method for transferring data to a customer relationship management platform. A system for transferring data to a customer relationship management platform includes a server computer which is adapted to connect to a network and further includes an application residing on the server. The application may be configured to include the customer relationship platform. The application may also be configured to communicate with a communication device, such as a mobile phone, for example, through the network. The application may detect a voice command from a user using the communication device, then connect the user to the customer relationship management platform. The application may then take an action with the customer relationship management platform based on the voice command, such as making a sales call, populating the customer relationship management platform database with sales data or prospective customer data, or taking some administrative action.

### CROSS-REFERENCE TO RELATED APPLICATION

This application claims the benefit of priority to U.S. Patent Application No. 61/843,028, filed Jul. 4, 2013, the contents of which are fully incorporated herein by reference.

### BACKGROUND

A typical salesperson engages in sales activity by making telephone calls to potential clients, sending emails by computer or smartphone to potential clients or by making in-person visits to meet with potential clients. Based on this activity, the salesperson will typically designate each potential client on a sales activity list in a manner that identifies the likelihood of a sale, such as designating each potential client as a cold, warm or hot prospect, for example. A salesperson will then typically follow up with each potential client until a sale is made.

Many popular customer relationship management (CRM) platforms exist to facilitate the organization of sales activities. Such CRM platforms, like SALESFORCE, MICROSOFT DYNAMICS OR SUGAR CRM, for example, are well-known in the art. However, the utility of a CRM platform is dependent on the willingness of a salesperson to enter relevant data about the potential client into the CRM platform. Often, a salesperson will not take the time to write notes after a sales call or meeting. Moreover, a salesperson often won't take the time to type relevant information into the database associated with the CRM platform. Without typing this information into the CRM platform database, thereby allowing the salesperson to track calls made, emails sent and meetings completed, a salesperson can forget valuable information and forget to follow up with a potential client.

### SUMMARY OF THE INVENTION

Embodiments of the present invention may include a method for transferring data to a customer relationship management platform. The method may include detecting a voice command from a user, connecting the user to the customer relationship management platform, and taking an action with the customer relationship management platform based on the voice command. The voice command may be detected through a communication device, which may be a mobile telephone. The action taken may be reading a list of prospective clients to the user, calling a prospective client, purchasing data, capturing keywords during a sales presentation given by the user during a call to a prospective client, an administrative task, and the like. If the action taken is an administrative task, the administrative task may be entering data into the customer relationship management platform

Embodiments of the present invention may include a system for transferring data to a customer relationship management platform. The system may include a server computer, which may be adapted to connect to a network. The server computer may further include an application residing on the server. The application may be configured to include the customer relationship platform. The application may also be configured to communicate with a communication device, such as a mobile phone, for example, through the network.

### BRIEF DESCRIPTION OF THE DRAWINGS

FIG. 1 shows a block diagram of a system for transferring voice data to a customer relationship management platform according to an embodiment of the present invention.

FIG. 2 shows a flow diagram of a method for transferring voice data to a customer relationship management platform according to an embodiment of the present invention.

### DETAILED DESCRIPTION

In the following description of preferred embodiments, reference is made to the accompanying drawings which form a part hereof, and in which are shown by way of illustration specific embodiments in which the invention may be practiced. It is to be understood that other embodiments may be utilized without departing from the scope of the present invention.

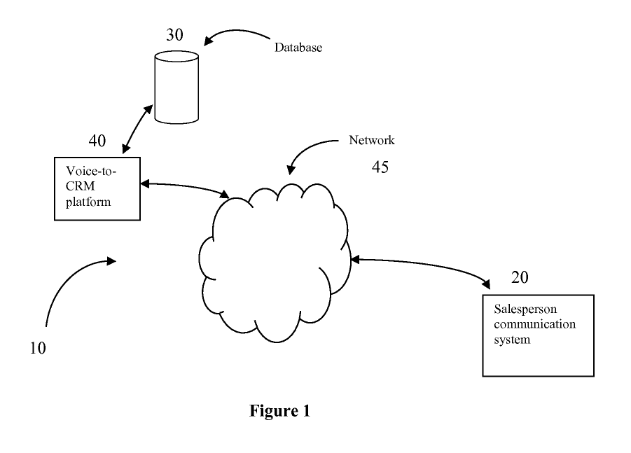

A system for transferring voice data to a customer relationship management platform 10 according to an embodiment of the present invention is shown in FIG. 1. FIG. 1 includes, for example, a salesperson communication device 20 and a voice-to-customer relationship management (CRM) platform 40. The salesperson communication device 20 and the voice-to-CRM platform 40 may both be connected to a network 45.

The network 45 may be a telephone or telecommunications network. For example, the network 45 may be a public or private network, a local area network or a wide area network, or may be the Internet. According to an embodiment of the present invention, the network 45 may be a wired network, such as a public switched telephone network, for example, which may include a network of physical wires like copper wires. Alternatively, the network 45 may be a network of fiber optic cables. According to another embodiment of the present invention, the network 45 may be a wireless telephone network such as the type used by mobile telephones in a cellular telephone system. According to another embodiment of the present invention, the network 45 may be a “WiFi” network or may be a voice over Internet protocol (VoIP) network. According to yet another embodiment of the present invention, the network 45 may be a combination of a wired network and a wireless network.

The salesperson communication device 20 may be any type of communication device with which a salesperson may communicate with another person or another device. Alternatively, the salesperson communication device 20 may be a communication system. For example, according to an embodiment of the present invention, the salesperson communication device 20 may be a traditional analog telephone system. Alternatively, the salesperson communication device 20 may be a simple residential telephone, a cordless phone, a mobile telephone, a smartphone, a feature phone or any other communication device into which voice signals or voice commands can be spoken.

According to the embodiment of the invention shown in FIG. 1, if the Internet is part of the network 45, the salesperson communication device 20 may be communicatively coupled to a network adapter. The network adapter may be a VoIP adapter, configured to accept voice or analog signals and convert such signals to data suitable for transmission over a data network. VoIP adapters are well-known in the art. The network adapter is then communicatively coupled to the network 45 such that the salesperson communication device 20, through the network adapter, may access the network 45. According to yet another embodiment of the present invention, the salesperson communication device 20 may be configured as a personal computer, a laptop computer or a tablet computer with a downloadable voice-to-data application, such as SKYPE, for example, thereby providing a session initiation protocol (SIP) connection.

The voice-to-CRM platform 40 shown in FIG. 1 may be a hosted application. For example, according to an embodiment of the present invention, the voice-to-CRM platform 40 may include a software program that resides on a computer system or a smartphone. The voice-to-CRM platform 40 may be configured as a software-as-a-service application and may exist as a cloud-based application. According to an embodiment of the present invention, the voice-to-CRM platform 40 may include a computer system having a processor coupled to a memory, storage, a network interface and an I/O interface. The processor may be one or more microprocessors and may include other logic circuits. The memory may include RAM, ROM, DRAM, SRAM and the like, and may include firmware, such as static data or fixed instructions, BIOS, system functions, configuration data, and other routines used during the operation of the processor. The memory may also provide a storage unit for data and instructions associated with applications and data handled by the processor. The storage unit provides non-volatile long term storage of data or instructions in the computer system. The storage unit may take the form of a disk, optical storage, SAN, tape, CD, DVD, or other reasonably high capacity addressable storage medium. In addition, the voice-to-CRM platform 40 may include one or more databases 30 in which information is stored and organized. The databases 30 may be relational databases, hierarchical databases, and the like.

According to an embodiment of the present invention, the voice-to-CRM platform 40 may be implemented as a website resident on a server computer. For example, the server computer may be programmed such that an application generates a website available to salespersons over a network. According to an embodiment of the present invention, salespersons calling the voice-to-CRM platform 40 may access the application hosted by the server computer via a website on the Internet.

According to yet another embodiment of the present invention, the voice-to-CRM platform 40 may be hosted on telephony application servers or trunk servers that are communicatively coupled to the network 45. The telephony application servers or trunk servers may be configured for voice recognition and speech and may be referred to generically as speech servers. For example, if the network 45 is a wired or wireless telephone network 45, the voice-to-CRM platform 40 may provide computer telephony integration such that a salesperson placing a call via the salesperson communication device 20 to the voice-to-CRM platform 40 may access speech servers implemented in the voice-to-CRM platform 40 via the telephone network 45. In this configuration, the speech servers implemented in the voice-to-CRM platform 40 may answer a call from the salesperson.

The voice-to-CRM platform 40 may be configured such that it accepts enrollment by salespersons. According to an embodiment of the present invention, salespersons may enroll with the voice-to-CRM platform 40 and enter information about themselves. According to an embodiment of the present invention, the voice-to-CRM platform 40 may register a salesperson identification (ID) number for a salesperson who enrolls with the voice-to-CRM platform 40. The salesperson ID number may be a telephone number used by the salesperson or may be another number. Once enrolled, the voice-to-CRM platform 40 may accept information about the salesperson that the salesperson would like to enter. The information may be stored and organized in one or more databases 30. Such information may include, for example, a contact list, an email address, social network account information, phone numbers, bank account numbers and the like. For example, a salesperson may enter the account information for the salesperson's TWITTER and FACEBOOK accounts so that the voice-to-CRM platform 40 will have this information readily available when the salesperson contacts the voice-to-CRM platform 40. As another example, a salesperson may enter the names of persons or places that the salesperson typically calls and telephone numbers associated with those names so that the voice-to-CRM platform 40 will have this information readily available when the salesperson contacts the voice-to-CRM platform 40.

According to an embodiment of the present invention, the voice-to-CRM platform 40 may be configured such that it utilizes voice recognition technology for entry of information. For example, the voice-to-CRM platform 40 may be configured such that any information being entered into it, such as a telephone number or the name of a person or place, may be entered simply by a salesperson or a client speaking into their telephones.

According to an embodiment of the present invention, the voice-to-CRM platform 40 may be configured such that when the salesperson calls the voice-to-CRM platform using the salesperson communication device 20, the voice-to-CRM platform 40 connects to the salesperson communication device 20 via the network 45 and logs into the salesperson account. The voice-to-CRM platform 40 may log on to the salesperson account using a “caller ID,” “media access control (mac) ID,” CRM ID or other identification mechanism associated with the salesperson communication device 20 as are well-known in the art. According to an embodiment of the present invention, the caller ID may limit the records that may be accessible by voice in that salespeople are often limited to accounts within their territory, to accounts assigned directly to them, and the like.

According to an embodiment of the present invention, a salesperson may enroll for service with the voice-to-CRM platform 40 by accessing a website associated with the voice-to-CRM platform 40. Once at the website, the salesperson may enter his or her mobile phone number, for example. The voice-to-CRM platform 40 may then send a text message or other type of message to the mobile phone belonging to the salesperson that includes an access number and a PIN. After receipt of the access number and the PIN, the salesperson can then dial the access number using his or her mobile phone and enter the PIN. The PIN will then be associated with the salesperson's mobile phone and the salesperson will be able to automatically utilize the services provided by the voice-to-CRM platform 40 simply by dialing the access number from the mobile phone to which the access number and PIN were sent. According to another embodiment of the present invention, the salesperson will be able to automatically utilize the services provided by the voice-to-CRM platform 40 simply by depressing a speed dial key on the mobile phone to which the access number and PIN were sent.

A variety of other methods may be used to enroll or register for service with the voice-to-CRM platform 40. For example, a salesperson may download an application, such as a mobile application, for example, to the salesperson's mobile phone, tablet computer, personal computer or the like. The application may be configured such that, as soon as the application is opened, the application automatically dials an access number for the voice-to-CRM platform 40, thereby automatically connecting the salesperson to the voice-to-CRM platform 40. According to another embodiment of the present invention, the application may be configured such that, as soon as the application is opened, a key is made available which, when pressed, causes the application to dial an access number for the voice-to-CRM platform 40, thereby connecting the salesperson to the voice-to-CRM platform 40. The salesperson may then configure his or her account in any manner offered by the voice-to-CRM platform 40.

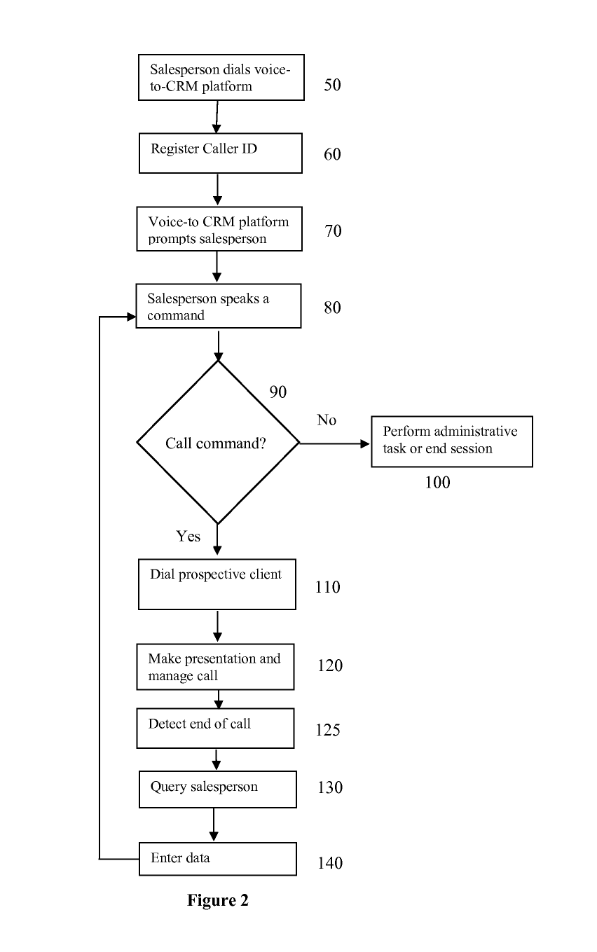

A method for transferring voice data to a customer relationship management platform according to an embodiment of the present invention is shown in FIG. 2. In FIG. 2, at step 50 a salesperson dials into a voice-to-CRM platform. The salesperson may dial into the voice-to-CRM platform from any type of telephone and from any location, thereby eliminating the need to utilize a desktop or laptop computer to use a customer relationship management application. For example, the salesperson may dial from a mobile telephone, a smartphone, a feature phone, an analog telephone such as a landline telephone, or the like. Also, the salesperson may dial into the voice-to-CRM platform from home, an office, while away from the home or the office, or from any other place that the salesperson is able to make a telephone call.

Once the salesperson has dialed into the voice-to-CRM platform, at step 60 the salesperson registers with the voice-to-CRM platform. The salesperson may register with the voice-to-CRM platform in a variety of ways. For example, according to an embodiment of the present invention, the salesperson may enter his or her login credentials directly into the telephone for identification by the voice-to-CRM platform. Entry of the login credentials may be accomplished in a variety of ways. For example, the salesperson may enter login credentials by using the telephone's touch-tone keypad or may press a pre-programmed speed dial key. Alternatively, the salesperson may enter login credentials by speaking them directly into the telephone for identification by the voice-to-CRM platform. According to another embodiment of the present invention, the salesperson's login credentials may be identified by the voice-to-CRM platform automatically by recognizing the telephone from which the salesperson is calling, or by recognizing the salespersons voice or spoken username or password.

Once the salesperson's login credentials have been identified and the salesperson is logged into the voice-to-CRM platform, at step 70 the voice-to-CRM platform prompts the salesperson to speak a command. In response to the prompt from the voice-to-CRM platform, at step 80 the salesperson speaks a command.

According to an embodiment of the present invention, at step 90, the voice-to-CRM platform determines if the command spoken by the salesperson is a command to make a call. If the command spoken by the salesperson is not a command to make a call, then at step 100 the voice-to-CRM platform may perform an administrative task as will be described in more detail below, or may end the session.

If the command spoken by the salesperson is a command to make a call, then at step 110 the voice-to-CRM platform may be directed to call a client or a prospective client in a variety of ways. For example, the salesperson may direct the voice-to-CRM platform to call a specific person such as, “Call John Smith,” in which case the voice-to-CRM platform will call the person identified by the salesperson. According to another embodiment of the present invention, the voice-to-CRM platform may direct the voice-to-CRM platform to “start prospecting,” in which case the voice-to-CRM platform will begin dialing a list of prospects that have been established in the voice-to-CRM platform. The voice-to-CRM platform may auto dial each prospective client or company and may announce the name of the prospective client or company to the salesperson before connecting the salesperson and the person or company being called, thereby eliminating the need see client or prospective client data or telephone numbers and improving the salesperson's ability to make an increased number of calls without having to visually manage or utilize contact records. According to an embodiment of the present invention, the voice-to-CRM platform may detect when a call is answered by a live person as opposed to an answering machine and may announce a contact name or company name before connecting the parties.

According to an embodiment of the present invention, the voice-to-CRM platform may be configured to integrate with third party databases that contain lists of prospective clients. For example, a salesperson may issue a voice command such as “list request” or “a list of prospects” or “prospect list” or the like to prompt the voice-to-CRM platform to read a list of prospective clients to the sales person. The salesperson's command may include parameters such as city, state, zip code, SIC code, industry name, employee size, annual sales, contact title, geographic proximity and the like. When the voice-to-CRM platform receives the command, it may run a third party database query and return the matching records by voice. According to an embodiment of the present invention, the voice-to-CRM platform may respond to the salesperson with information relevant to the request, such as, for example, “There are 1,758 records that match your request.” The salesperson may then take appropriate action, such as buying the data by voice command, for example, thereby causing the voice-to-CRM platform to purchase the records and import the records into the database of the voice-to-CRM platform associated with the account of the salesperson. The salesperson can then begin calling or sending emails or text messages by issuing an appropriate voice command into the voice-to-CRM platform. Configuring the voice-to-CRM platform in this manner saves time and eliminates the need to use corporate IT staff to source, buy and import prospect data. Salespeople can also buy smaller amounts of data as needed on demand. The ability to find and buy contact records by voice facilitates an increase in productivity and sales.

Once the salesperson is connected to a client or a prospective client, at step 120 the salesperson makes a sales presentation and the call is managed by the voice-to-CRM platform. For example, the voice-to-CRM platform may perform a variety of tasks during the sales presentation. According to an embodiment of the present invention, the voice-to-CRM platform “listen” to the conversation and capture keywords and data information for the sales person. For example, using voice recognition technology, the voice-to-CRM platform may capture a client's credit card number, shipping instructions, and the like. Once the data is captured, the voice-to-CRM platform may convert the voice entry into text and write the text into a database, eliminating the need for the salesperson to enter such data.

According to an embodiment of the present invention, the voice-to-CRM platform may be configured to allow a salesperson to record a sales presentation and play it when making a call. For example, the voice-to-CRM platform may be configured such that one presentation is played when a live person answers the call and another presentation is played when an answering machine answers the call or a voice mailbox is detected. According to an embodiment of the present invention, if a live person answers the call, the voice-to-CRM platform may detect the end of a pre-record sales presentation and then prompt the prospective client by asking, “Would you like to order now?” or “Would you like to connect to a live agent?” or “Would you like to be removed from our list?” and the like. Once the prospective client responds by voice, the voice-to-CRM platform may take the action requested by the prospective client, such as, for example, processing a credit card or connecting the prospective client to a live agent. Also, according to an embodiment of the present invention, the voice-to-CRM platform may use suggestive voice prompts and voice recognition to narrow the list of prospective clients to only those interested in buying or talking further.

According to yet another embodiment of the present invention, the voice-to-CRM platform may also manage inbound calls. For example, if a client or prospective client calls the salesperson, the voice-to-CRM platform may initiate a reverse phone number lookup using the client's or prospective client's caller ID to obtain from the voice-to-CRM platform database a record of the caller and then may read the information from the record to the salesperson before the salesperson accepts the call. For example, when a client or prospective client calls the salesperson and the salesperson answers the call, the voice-to-CRM platform, before connecting the salesperson with the caller, may say “Hello, it's your voice-to-CRM platform and you have a call from John Smith in Los Angeles, Calif. You previously forecasted a sale for 5,000 mobile phones on Jan. 18, 2013. Your last call was Feb. 12, 2013. The call notes say John was on vacation, call back in March. Connecting you now—go ahead please” or the like. This embodiment of the present gives the salesperson relevant data about the client or prospective client before connecting the salesperson with the caller.

According to an embodiment of the present invention, at step 125 the voice-to-CRM platform detects a word or a phrase such as “goodbye,” “thanks for calling” or the like that indicates the end of the call. When the voice-to-CRM platform detects the end of the call, at step 130 the voice-to-CRM platform queries the salesperson in an effort to perform a variety of administrative tasks. For example, according to an embodiment of the present invention, the voice-to-CRM platform may ask the salesperson “Did you reach a decision maker?” or “Is this prospect interested?” or “What notes would you like to keep?” or “When do you want to call again?” or “Do you want to forecast a sale?” or “Do you need to schedule any follow up actions?” or the like. The salesperson may then answer the questions by voice and the voice-to-CRM platform may transcribe the voice into text and write the text into the database at step 140. Thus, the database may be automatically updated, relevant sales call data may be captured and logged and action items may be scheduled, all using voice command and eliminating the need for typing.

For example, according to an embodiment of the present invention, the voice-to-CRM platform may be used to forecast a sale. In this embodiment, the salesperson may speak into the telephone the name of products or services sold, quantities ordered, shipping dates, closing dates, payment terms, dollar value and other data relevant to a pending sale or sales forecast. The voice-to-CRM platform may then transcribe the salespersons voice into text and write the text into the database.

According to another embodiment of the present invention, the voice-to-CRM platform may be used to generate a report. For example, the voice-to-CRM platform may track all calls, meeting notes generated by voice and the like, whether from home, the office, or a mobile phone, and transcribe all such activity and write it into the database, thereby allowing a report to be generated to see the date and time of each call or appointment, the duration of each call or appointment, the results of the call and the like. The voice-to-CRM platform may aggregate calls or meeting notes whether completed from home, work, or from a mobile phone and generate a report. Thus, management or other persons who want to review the salespersons activity can easily and efficiently review the voice-to-CRM platform reports and can act accordingly.

A variety of other tasks may be performed when the voice-to-CRM platform queries the salesperson at step 130. For example, according to an embodiment of the present invention, the voice-to-CRM platform may remind a salesperson whom to call upon when the salesperson logs in to the voice-to-CRM platform. According to another embodiment of the present invention, the voice-to-CRM platform may try to find a salesperson by dialing the salesperson on the salesperson's home phone, business phone or mobile phone. Once the identity of the salesperson has been confirmed, the voice-to-CRM platform may then remind the salesperson whom to call and then automatically place the call and connect the parties, thereby preventing lost business opportunities by using automatic reminders with automatic re-connections.

According to another embodiment of the present invention, the voice-to-CRM platform may be configured to read a database. For example, the voice-to-CRM platform may be configured to look up contact records in a database by voice command and then read the database records by converting the text into speech, thereby allowing a salesperson to have remote voice access to all contacts and obtain information stored simply by issuing a voice command and listening to the response.

According to an embodiment of the present invention, the voice-to-CRM platform may be configured such that when a sales call is completed, the voice-to-CRM platform can ask the client or prospective client if such client or prospective client was satisfied with the service provided by the salesperson, live agent, customer service representative and the like. For example, the voice-to-CRM platform may be configured such that the client or prospective client answers some brief questions, such as to report his or her level of satisfaction with the call, for example. Upon receiving a response, the voice-to-CRM platform may convert the answers into text and log the information into a database for later review. According to an embodiment of the present invention, the voice-to-CRM platform may be configured to thank the prospective client and provide information on how to re-connect if necessary. This can improve the quality of service provided to inbound or outbound calls.

Once data has been entered into the database at step 140, the process may continue at step 80, whereby the salesperson may issue a command. For example, at this point the salesperson may be ready to make his or her next call. The use of the voice-to-CRM platform makes it possible for the salesperson to quickly and efficiently make sales calls, reports results, schedule next actions and begin making the next call in a manner much faster than traditional manual methods.

While particular embodiments of the present invention have been shown and described, it will be obvious to those skilled in the art that the invention is not limited to the particular embodiments shown and described and that changes and modifications may be made without departing from the spirit and scope of the invention.

What is claimed is:

1. A method for transferring data to a customer relationship management platform comprising:
detecting a voice command from a user;
connecting the user to the customer relationship management platform; and
taking an action with the customer relationship management platform based on the voice command.

2. The method of claim 1, wherein the voice command is detected through a communication device.

3. The method of claim 2, wherein the communication device is a mobile telephone.

4. The method of claim 1, wherein the action taken is reading a list of prospective clients to the user.

5. The method of claim 1, wherein the action taken is calling a prospective client.

6. The method of claim 1, wherein the action taken is purchasing data.

7. The method of claim 1, wherein the action taken is capturing keywords during a sales presentation given by the user during a call to a prospective client.

8. The method of claim 1, wherein the action taken is an administrative task.

9. The method of claim 8, wherein the administrative task is entering data into the customer relationship management platform.

10. A system for transferring data to a customer relationship management platform comprising:
a server computer, the server computer adapted to connect to a network; and
an application residing on the server, the application configured to include the customer relationship platform and further configured to communicate with a communication device through the network,
wherein the application is configured to:
detect a voice command from a user using the communication device;
connect the user to the customer relationship management platform; and
take an action with the customer relationship management platform based on the voice command.

11. The system of claim 10, wherein the communication device is a mobile telephone.

12. The system of claim 10, wherein the action taken is reading a list of prospective clients to the user.

13. The system of claim 10, wherein the action taken is calling a prospective client.

14. The system of claim 10, wherein the action taken is purchasing data.

15. The system of claim 10, wherein the action taken is capturing keywords during a sales presentation given by the user during a call to a prospective client.

16. The system of claim 10, wherein the action taken is an administrative task.

17. The system of claim 16, wherein the administrative task is entering data into the customer relationship management platform.
